(19) United States
(12) Patent Application Publication
(10) Pub. No.: US 2008/0126836 A1
(43) Pub. Date: May 29, 2008

(54) Real Time Data Storage Monitoring and Administration

(75) Inventors: Marc DiZoglio, Salem, NH (US); Greg Morris, Lawrence, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Raid Incorporated, Lawrence, MA (US)

(21) Appl. No.: 11/937,914

(22) Filed: Nov. 9, 2007

Related U.S. Application Data
(63) Continuation of application No. 10/914,651, filed on Aug. 9, 2004, now abandoned.
(60) Provisional application No. 60/493,684, filed on Aug. 8, 2003.

(51) Int. Cl. G06F 15/16; G06F 11/20

(52) U.S. Cl. 714/4; 709/217; 714/E11.08

(57) ABSTRACT

The remote monitoring and administration system and method provides proactive monitoring and maintenance of one or more storage systems at remote locations from a central monitoring system. The remote locations include at least one data storage system connected to the Internet. The central monitoring system includes one or more cluster nodes connected to the Internet. The monitoring and maintenance of the storage system(s) is preferably provided via a substantially constant live real-time connection over the Internet. In some embodiments, the invention includes a LAN port and the data storage system and central monitoring system are connected via a standard IP address.

### CROSS-REFERENCE TO RELATED APPLICATIONS

The present invention claims the benefit of co-pending U.S. Provisional Patent Application Ser. No. 60/493,684, filed on Aug. 8, 2003, which is fully incorporated herein by reference.

### TECHNICAL FIELD

The present invention relates to data storage systems and more particularly, to real time storage monitoring and administration using a substantially constant, real-time connection to the storage system from a remote location.

### BACKGROUND INFORMATION

The ever-increasing amount of digital data brought by the “information age” often must be stored in sophisticated data storage systems. Corporations, educational institutions and government departments all face a similar challenge—how to manage, administer and maintain their data storage assets. The main challenge is to ensure that data is always available. There are common methods of redundancy in storage system architectures that allow for continued access and operation in the event of a component failure. However, the increase of capacity per hard disk drives has led to a higher rate of media errors within individual hard disk drives when used in disk arrays. The sheer amount of blocks per disk platter and handling of these blocks is the fundamental reason for this increase in media errors. This poses an additional challenge to entities attempting to properly maintain their disk arrays.

There are also common event notification systems that are implemented as part of storage systems to produce alerts of any and all system events. Some common notification systems include E-mail notification using SMTP mail and pager and fax notification using a standard modem or SNMP (Simple Network Management Protocol) over TCP/IP. Entities can implement some type of centralized monitoring package that collects SNMP event information and allows for management in complex networks. These event notification methods allow administrators to react when problems occur.

Another problem that faces many entities is the lack of expertise in storage management or the lack of funding to properly manage and maintain a storage system on a 24×7 basis. Many entities have staff to manage their IT infrastructure on a part time basis while the data assets should be available to users 24×7. When an event occurs in this type of environment, the administrators rely on traditional event notification systems to alert them of such problems. In many cases the reaction time from the event to the response puts the data assets in a vulnerable state due to potential storage system degradation. The problem that faces most organizations is how to cost-effectively manage and maintain their data storage assets while ensuring 99.999% uptime.

The practice of “monitoring” electronic equipment is widely used in the IT world. Various tools can be incorporated as part of a monitoring system or component. The tools can include a combination of software and hardware integrated and implemented to provide “alerts” when a system event occurs. The primary methods of monitoring equipment are based on standard networking and communication protocols. However, the methods currently deployed are based on reaction to event and failure warnings.

One example of a method of monitoring electronic equipment uses SNMP (Simple Network Management Protocol). Many electronic devices are SNMP compliant and contain agents or information about themselves in MIBs (Management Information Bases). The MIB data is sent to a central collection point when an event occurs on a device. Once an event is received from the device, notification and alerts are sent.

Another example of monitoring electronic equipment uses E-mail Notification. Equipment and devices can be configured to send e-mail alerts when an event occurs within a specific device.

A further example of monitoring electronic equipment uses modem alerts. Equipment can be configured to use a standard modem and phone line to send out alerts when events occur. The modem string can be set to dial a pager, fax or modem bank at a remote location. The string or message will allow for some information to be displayed regarding the nature of the event that has occurred.

Event notifications can be delivered to internal personnel/stations, an off-site location or to a third-party service provider. When using these existing monitoring techniques, there is some level of reaction taking place. Once a party receives notification of an event, there are methods of remotely connecting to a device, for example, using the network/internet, a dedicated modem, or a phoneline. Once connected, the practice of diagnosing, troubleshooting, managing and maintaining equipment can be performed. The main problem with relying on notification alerts provided by these existing techniques is the reactive nature of the service.

Accordingly, there is a need for a proactive data storage monitoring and administration service that can maintain a substantially constant real-time, live connection with various storage systems that are deployed. There is also a need for a proactive data storage monitoring and administration system and method designed to maximize the availability and efficiency of the data storage assets of an organization while at the same time minimizing the amount of infrastructure needed to properly maintain and manage such assets.

### SUMMARY

In accordance with one aspect of the present invention a storage monitoring and administration system is provided. The storage monitoring system comprises a plurality of remote storage management systems, each including at least one connection to a data storage system to be monitored, software for managing and monitoring the data storage system, and a connection to the internet. The storage monitoring system also comprises a central monitoring system including a connection to the Internet. The central monitoring system maintains a constant, real-time live connection with each of the remote storage management systems over the Internet. The connection to the Internet is preferably a TCP/IP connection, which maybe used to establish a dedicated virtual private network (VPN) between the central monitoring system and each remote storage management system at a customer's site. Each remote storage management system preferably has at least one dedicated IP address within the respective customer's network.

Each remote storage management system is preferably connected to the data storage system using an in-band connection and/or an out-of-band connection. The storage management system preferably comprises at least one storage application including a software interface acting as a launch point for management and monitoring applications. The remote storage management system also includes a secure communications server for communicating with the central monitoring system. Multiple remote storage management systems can be connected to each storage system to provide fail-over support.

Each central monitoring system preferably includes a plurality of cluster nodes in communication with at least one thin client. Each cluster node comprises a secure communications server agent for communicating with the thin client and a secure communications client for communicating with the remote storage management system. Each cluster node further comprises a fail-over agent to provide fail-over support.

In accordance with another aspect of the present invention, a remote storage management system is provided for monitoring a storage system. The remote storage management system comprises an operating system and at least one storage application. The remote storage management system further comprises an event monitor for monitoring events in the storage system and for receiving data and alerts at a real-time level, and a secure communications server for communicating with the central monitoring system. The storage management system also comprises an in-band connection to the storage system and an out-of-band connection to the storage system. The storage management system further comprises a TCP/IP connection to the Internet and preferably has a dedicated IP address within a customer's network.

In accordance with a further aspect of the present invention, a method is provided for proactively monitoring at least one remote storage system at a remote location using a central monitoring system. The method comprises: establishing and maintaining a substantially constant, live real-time connection between the central monitoring system and a remote storage management system connected to the remote storage system(s) at the remote location; receiving data and alerts from the storage system(s) at the remote storage management system at a real-time level; accessing the data and alerts over the live real-time connection; and displaying the data and alerts in real-time at the central monitoring system.

One preferred method further comprises setting thresholds within the storage system(s) to provide alerts indicating problems before the problems occur. Another preferred method comprises providing remote administration and management of the storage system(s) over the real-time connection using the central monitoring system. A further preferred method comprises providing alert notifications to personnel associated with the central monitoring system and/or to personnel associated with the remote storage system. Yet another preferred method comprises generating reports based on the data and alerts and providing the reports to the customer(s) with the storage system(s) being monitored.

According to another aspect of the present invention, a method of providing a remote monitoring service comprises: ascertaining a customer's configuration at a customer's location; configuring a remote storage management system at a customer's location depending on the customer's configuration; establishing and maintaining a live real-time connection between a central monitoring system and the remote storage management system configured at the customer's location; receiving data and alerts from the storage system at the remote storage management system at a real-time level; accessing the data and alerts over the live real-time connection; and displaying the data and alerts in real-time at the central monitoring system. According to one preferred method, the step of configuring the remote storage management system includes connecting a storage management appliance to the storage system at the customer's location and assigning the storage management appliance a dedicated IP address within the customer's network. According to another preferred method, the step of configuring the remote storage management system includes configuring an existing host system at the customer's location to connect to the central monitoring system.

According to another aspect of the present invention, a system for storage monitoring and administration for remotely monitoring and providing administration to a data storage system. The storage monitoring and administration system includes at least one remote data storage system connected to a network and a central monitoring system connected to the at least one remote data storage system via the network. The central monitoring system maintains a substantially constant, real-time live connection with each of the remote data storage system(s) over the network.

Some embodiments of this aspect of the invention include: where the connection to the network by each of the data storage system(s) and the monitoring system is a TCP/IP connection; and/or where the invention further includes a LAN port wherein the at least one remote date storage system is connected to the central monitoring system via an IP address.

According to another aspect of the present invention, a method for proactively monitoring and providing administration to a remote data storage system at a remote location. The method includes the following steps: establishing and maintaining a substantially constant, live real-time connection between a central monitoring system and a remote data storage system at the remote location; receiving data and alerts pertaining to the data storage system; accessing the data and alerts over the real-time connection; and displaying the data and alerts in real time at the central monitoring system. Some embodiments of this aspect of the invention may include the step of providing remote administration and management of the remote storage system.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description, taken together with the drawings wherein:

FIG. 1 is a functional block diagram of a storage monitoring and administration system for remotely monitoring and managing a data storage system, according to one embodiment of the present invention;

FIG. 2 is a functional block diagram of the local side of the monitoring and administration system, according to one embodiment of the present invention;

FIG. 3 is a functional block diagram of the remote side of the monitoring and administration system, according to one embodiment of the present invention;

FIG. 4 is a schematic diagram of another embodiment of the storage monitoring and administration system;

FIG. 5 is a flow chart illustrating one method of providing a remote monitoring and management service;

FIGS. 6 and 7 are schematic diagrams of different configurations of the storage monitoring and administration system based on different customer environments; and

FIG. 8 is a schematic diagram of one configuration of the storage monitoring and administration system, according to one embodiment of the present invention.

### DETAILED DESCRIPTION OF THE PREFERRED EMBODIMENTS

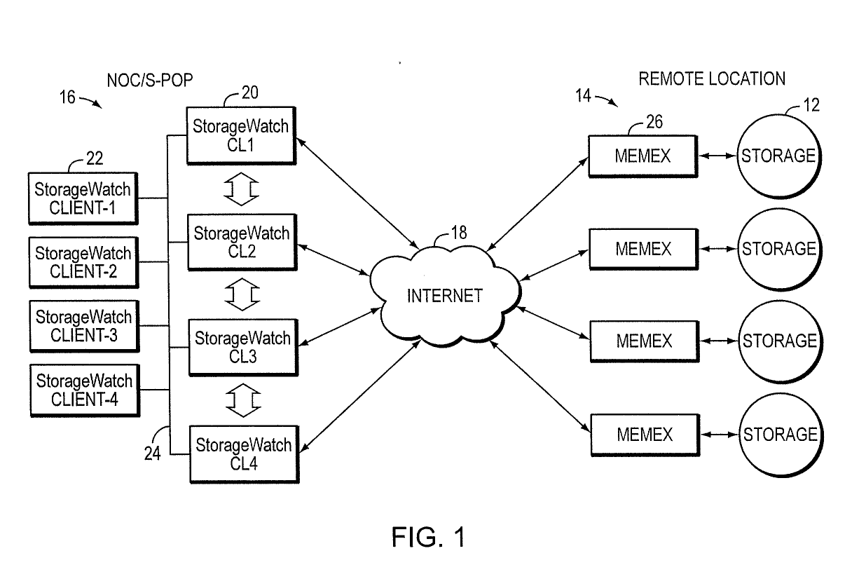

Referring to FIG. 1, a monitoring and administration system and method for remotely and proactively monitoring and/or managing one or more storage systems is described in greater detail. The system and method preferably use a variety of COTS (commercial off-the-shelf) hardware, software and standard networking services and protocols combined in a manner that allows a remote proactive management and monitoring service over the Internet. The system and method includes of a number of layers and systems at various locations, as will be described in greater detail below.

The storage systems 12 located at remote locations 14 (e.g., customer sites) are monitored and managed from a central monitoring system 16, such as a NOC (Network Operation Center) or S-POP (Storage Point of Presence). The central monitoring system 16 is capable of establishing a substantially constant, live real-time connection with the storage systems 12. The live real-time connection is preferably provided by a dedicated connection to the Internet 18. The connection to the Internet 18 is maintained substantially constantly (i.e., except for minor interruptions that might be caused, for example, by down equipment or power outages). Although not as preferable, a dial-up connection can also be used to accomplish many of the features of the present invention although it is not as preferable.

The monitoring and administration system and method is preferably designed to allow for ease of scalability and redundancy at multiple levels. This design allows for a plurality of storage systems 12 to be monitored from a single or multiple redundant locations. Each central monitoring system 16 (e.g., NOC/S-POP) is preferably configured for redundancy and based on the number of storage systems 12 to be monitored. The central monitoring system 16 preferably includes a group of “cluster nodes” 20 that communicate with thin clients 22 over a network 24 (or the Internet). The nodes 20 also communicate through the Internet 18 to one or more remote storage management systems 26 connected to the storage system(s) 12 at each monitored location 14.

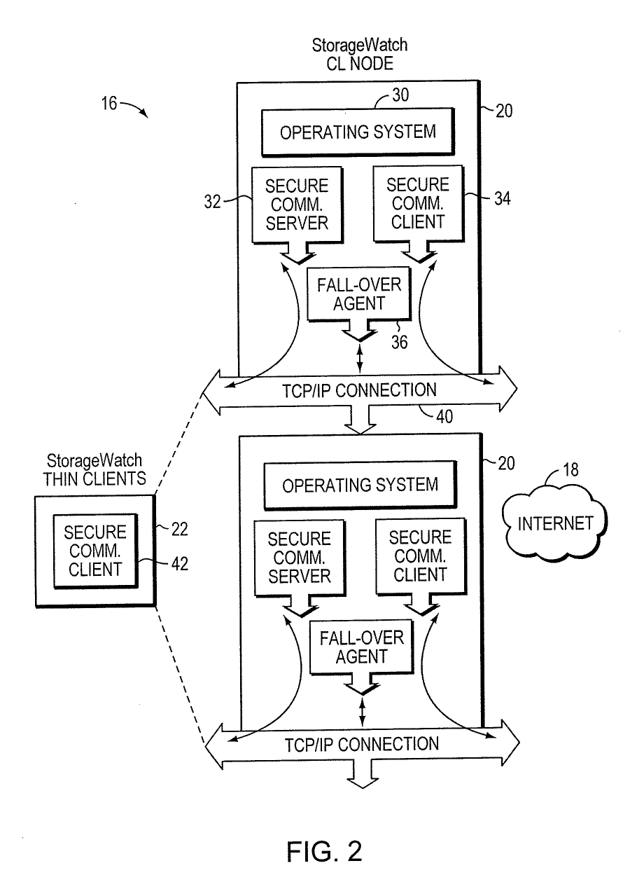

Referring to FIG. 2, one preferred embodiment of the central monitoring system 16 is described in greater detail. Each node 20 can be implemented using standard network operating systems supported TCP/IP protocols. Each cluster node 20 contains an operating system 30, which can be the type available under the name WINDOWS, SOLARIS or LINUX. Beneath the O/S level, resides a secure communications server agent 32 and a secure communications client agent 34 for providing a secure communications link with the thin client(s) 22 and the remote storage management system(s) 26, respectively. Depending on the operating system 30, the secure communications link can be established using a number of options including Terminals Services with a secure VPN (virtual private network) or SSH (Secure Shell script).

In this embodiment, communication data is received by the secure communication client agent 34 from the remote storage management system(s) (not shown in FIG. 2, See FIGS. 1 and 3, 26) via a TCP/IP connection 40. At the same time, a secure link is established between the thin client(s) 22 and the cluster nodes 20. Each thin client 22 includes a secure communication client agent 42 connected to the secure communication server agent 32 in the node 20 via the TCP/IP connection 40. Thus, information is retrieved by the thin client 22 that was originally retrieved from the remote storage management system at a remote location.

Each cluster node 20 also includes a fail-over agent 36 that allows for high-availability in the event of a node 20 within the cluster failing. Cluster node configuration data 20 is passed back and forth between the cluster nodes 20 over the TCP/IP connection 40. Should a single node failure occur, data from the remote storage management system 26 is automatically re-routed to the surviving nodes within the cluster using Windows clustering protocols that are integrated into the Windows operating system. Thus, the thin clients 22 and remote storage management systems have essentially no interruption in transferring and receiving data.

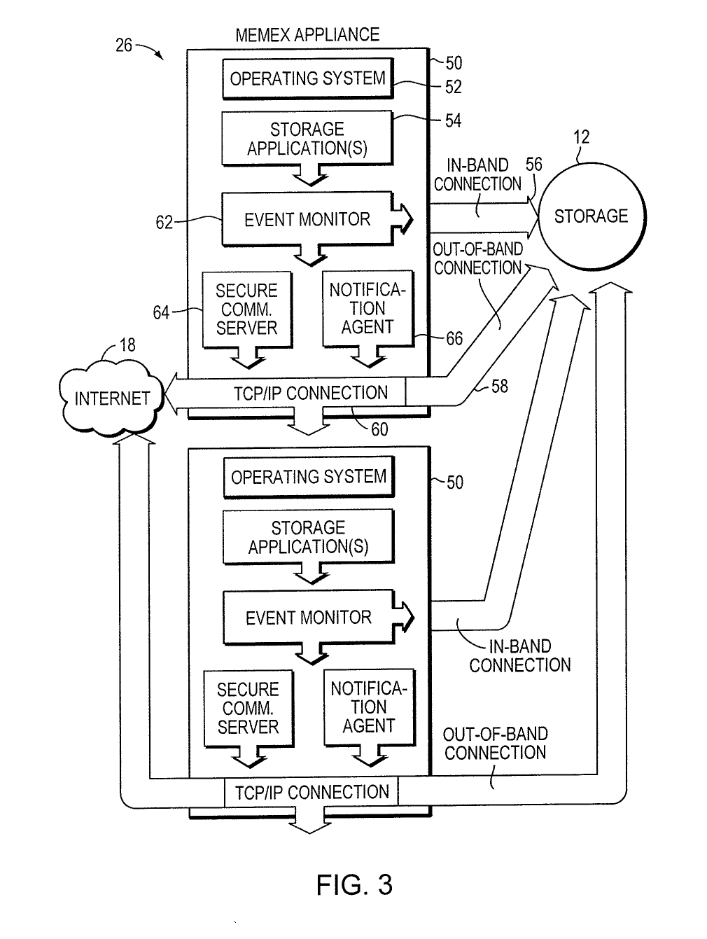

Referring to FIG. 3, one preferred embodiment of the storage management system 26 is described in greater detail. The storage management system 26 includes one or more server appliances 50 (also referred to as the Memex) that essentially act as the gateway to the central monitoring system 16 while providing full storage management and monitoring tools. Each storage management server appliance 50 preferably includes an operating system (O/S) 52, which can be WINDOWS, SOLARIS or LINUX based. Beneath the O/S layer lies a storage application layer 54 including management and monitoring applications. The storage application layer 54 can also include a software interface, acting as a centralized launch point to all of the management and monitoring applications. One embodiment of the front-end software interface is based on a visual basic script.

Communication can be established to the storage system(s) 12 using both an “in-band” connection 56 and an “out-of-band” connection 58. The in-band connection 56 can use a fibre-channel or SCSI interface to transfer monitoring and management data back and forth from the storage management server appliance 50 to components of the storage system 12. The additional “out-of-band” connection 58 can be established using one of two types of out-of-band connections. One type of out-of-band connection is a standard ethernet connection where the management data is transferred back and forth from the server appliance 50 to the components of storage system 12 over a TCP/IP connection 60. Another type of out-of-band connection method uses the RS-232 standard over a serial interface connection.

Beneath the storage application layer 54 resides an event monitor 62. The event monitor 62 receives data and alerts from the storage system 12 at a real-time level. A secure communications server agent 64 communicates with the secure communications client agent (not shown, See FIG. 2,34) on the node(s) (not shown, See FIG. 2,20) in the central monitoring system (not shown, See FIG. 2,16). This allows the central monitoring system 16 to access and monitor the data received by the event monitor 62 and allows the central monitoring system 16 to remotely configure and maintain the storage system 12. As the event monitor 62 receives alerts, they are passed down to the secure communications server agent 64 and to a notification agent 66 which handles event notification. Event notification can be provided, for example, via e-mail, fax, network broadcast, SNMP traps, pager, or other notification techniques.

The storage management server appliance 50 is also designed for fail-over, wherein fail-over data is passed over the TCP/IP connection 60 to another storage management server appliance 50. Thus, communication with the storage system 12 and the central monitoring system 16 remains essentially uninterrupted in the event of failure. The storage management appliance 50 can also be configured to provide further functionality such as storage virtualization, remote replication and disaster recovery.

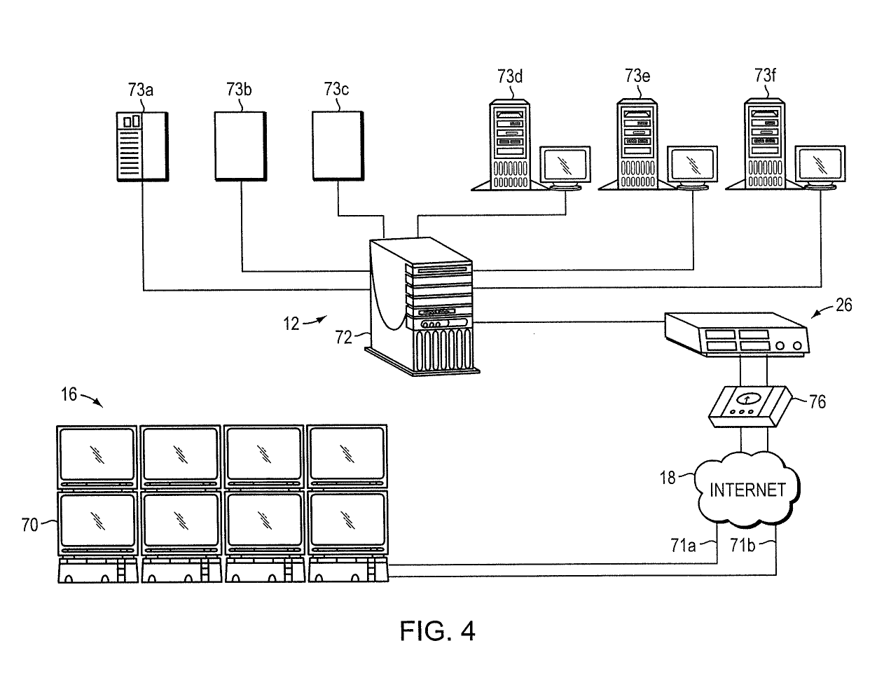

Referring to FIG. 4, one exemplary embodiment of the storage monitoring system is shown. In this exemplary embodiment, the central monitoring system 16 is a fault-tolerant network operations center (NOC) 70 having redundant communication links 71a, 71b to the Internet 18. The storage system 12 being remotely monitored is a storage array 72 such as the type available under the name XANADU from Raid, Inc. This provides a platform independent open storage solution that allows for shared data in a heterogeneous environment including different systems 73a-f from different vendors (e.g., SUN, HP 9000, RS6000, Linux, and NT). Other types of storage systems can also be monitored including, but not limited to, any type of storage area network (SAN), network-attached storage (NAS) and direct-attached storage (DAS). The storage system can also include switches and/or other equipment that can be monitored.

In this exemplary embodiment, the storage management system 26 includes the storage management server appliance (not shown) connected to the storage array 72 and connected to the Internet 18 behind a firewall 76 at the customer's site. The server appliance provides communication from the storage array 72 to the NOC 70. The communications agents running on the server appliance include a primary agent to facilitate communication with the storage array 72 and a secondary agent to facilitate communication with the NOC 70. These agents are services that run in the background of the operating system and are not active applications. The server appliance provides standard IP based monitoring using SNMP and the World Wide Web. The redundant communication links 71a, 71b between the NOC 70 and the customer site ensure substantially constant monitoring. Thus, the NOC 70 is fault tolerant and provides full 24×7 proactive monitoring of the storage array 72 as well as remote configuration and maintenance, as will be described in greater detail below.

Another embodiment of establishing a connection to the remote storage is described herein. This embodiment eliminates the need for a storage management appliance at the customer location. Specific storage systems allow for direct access to the data storage and communication with the data storage from the central monitoring system. The addition of a LAN (Local Area Network) port allows the data storage systems to be connected via a standard IP address. There are multiple methods for connecting directly from the central monitoring station directly to the data storage system. In all methods of establishing a connection from the central monitoring station to the remote data storage system that resides behind a firewall, the firewall on the data storage system is configured to allow address translation. This process includes opening specific communications ports in the firewall to a dedicated range of IP addresses of the central monitoring station.

One embodiment is the Out-of-band connection via Telnet method. In this embodiment, the storage system can be assigned an IP address on the customer network that will allow for direct access to the system for visual monitoring and the execution of maintenance and administrative tasks. Once the storage system has been assigned an IP address and the firewall to address translation has been setup, a telnet session can be launched using such programs as DOS by Microsoft Corporation or Hyperterminal by Microsoft Corporation. Security for this method includes firewall to address translation and username/password authentication.

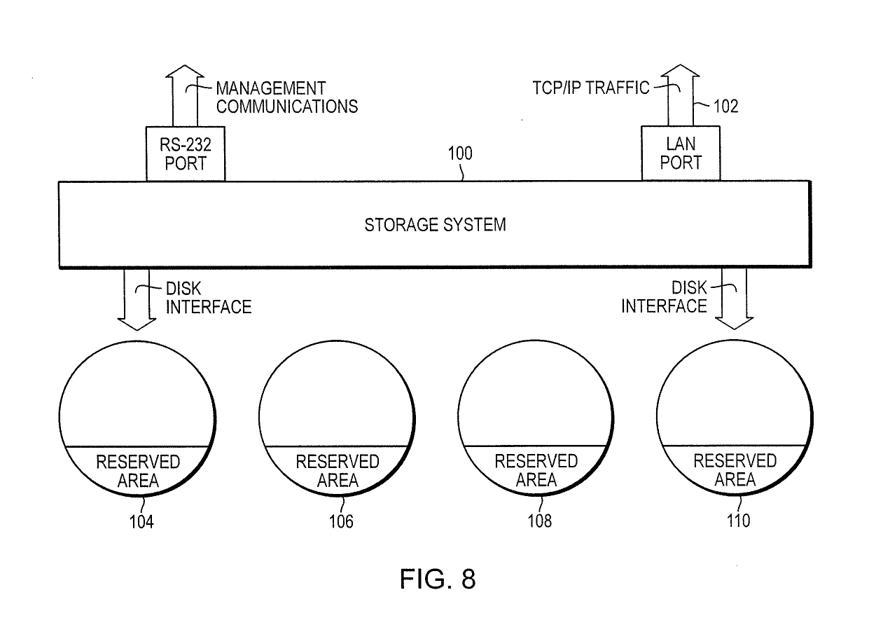

Referring now to FIG. 8, another embodiment is the Out-of-Band Via Java Based Software and Web Browser method is depicted. The data storage system 100 is connected via a LAN (Local Area Network) port 102 which allows the data storage system 100 to be connected via a standard IP address. In this embodiment, the storage system 100 can be assigned an IP address on the customer network that will allow for direct access to the system for visual monitoring, remote event notification setup and the execution of maintenance and administrative tasks. This method requires a software to be installed on the storage array itself and not at the remote storage management system as had been practiced with previous methods. At the time of setup of the storage system 100, a small percentage (250 MB) of each physical disk drive is reserved 104, 106, 108, 110 for such purposes as the installation of Java based administrative software. One such example of this software is the type being named RAIDWatch from Infortrend Corporation. Once the software is installed on the storage system 100, the storage system 100 is assigned an IP address and then the firewall to address translation is been setup. Next, a web-browser, such as the type being named Internet Explorer by Microsoft or Netscape by Netscape, can be launched at which time the IP address of the storage system 100 can be input. This will enable a Secure Socket Layer (SSL) connection and a username and password will be required. Security for this method includes firewall to address translation, SSL (Secure Socket Layer) and username/password authentication.

Another embodiment is the Out-of Band Via Java Based Software method. In this embodiment, the storage system can be assigned an IP address on the customer network that will allow for direct access to the system for visual monitoring, remote event notification setup and the execution of maintenance and administrative tasks. This method requires a software program to be running locally at the Central monitoring station. One such example of this software is the type being named RAIDWatch from Infortrend Corporation. Once the storage system has been assigned an IP address and the firewall to address translation has been setup, the software can be launched at the central station at which time an IP address of the remote storage system will be input. This will enable a Secure Socket Layer (SSL) connection and a username and password will be required. Security for this method includes firewall to address translation, SSL (Secure Socket Layer) and username/password authentication.

In addition to the method of establishing and maintaining a live real-time connection between the central monitoring system and storage system, the method and system additionally includes administration and maintenance functions that takes place on a the remote storage system from the central monitoring station.

The following are examples of functions performed on the remote storage system from the central monitoring station are examples. Additional functions may be performed and these examples are not intended to limit the invention.

One function is media scans. Media Scans are performed to examine each physical disk drive in an array for the presence of bad blocks. This process is critical in ensuring rebuilds complete successfully in the event of a drive failure. Media Scans are a background process that examines one drive at a time to limit its impact on performance of the system.

Another function is parity regeneration. Parity Regeneration is performed to ensure that the parity information stored on the logical drive is accurate. Finally, firmware upgrades are a function performed on the remote storage system. Firmware upgrades are part of the normal maintenance of a storage system. The application of new code on some or all storage sub-components will address bug fixes and/or apply enhancements to the array.

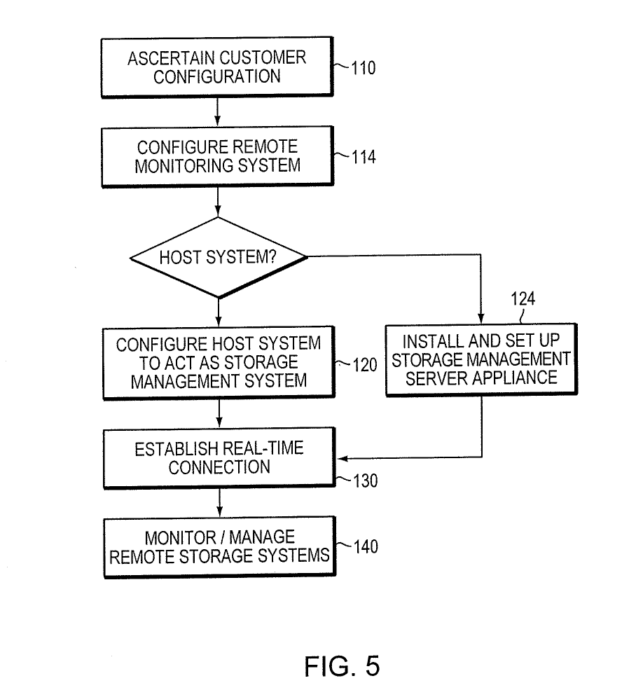

Referring to FIG. 5, one method of providing a remote monitoring and management service is described. To configure the remote monitoring system according to this method, the customer's system configuration is first ascertained, step 110. This includes determining whether or not the customer already has a system that can be used as a storage management system. If not, a storage management server appliance can be provided and installed. Ascertaining the customer's configuration also includes determining what types of Internet access are available at the customer site (e.g., TI, dialup) and which operating system is being used (e.g., WINDOWS, LINUX, SOLARIS). Ascertaining the customer's configuration further includes determining if the customer has a firewall on its network. If so, the central monitoring system is preferably given access through the firewall and certain ports are preferably allowed to stay open so out-monitoring software can connect to the customer's system. Also, the equipment to monitor and the current firmware and boot records for the equipment is determined. Customer contact information must also be obtained (e.g., company names, contact names, telephone numbers, e-mail addresses, pager numbers, etc.) for the individuals who should be contacted in case of system problems.

The customer configuration information is recorded for each customer and the remote monitoring system is configured for each customer using the customer configuration information, step 114. If the customer location includes a host system, the host system can be configured to act as the storage management system and to connect to the central monitoring system, step 120.

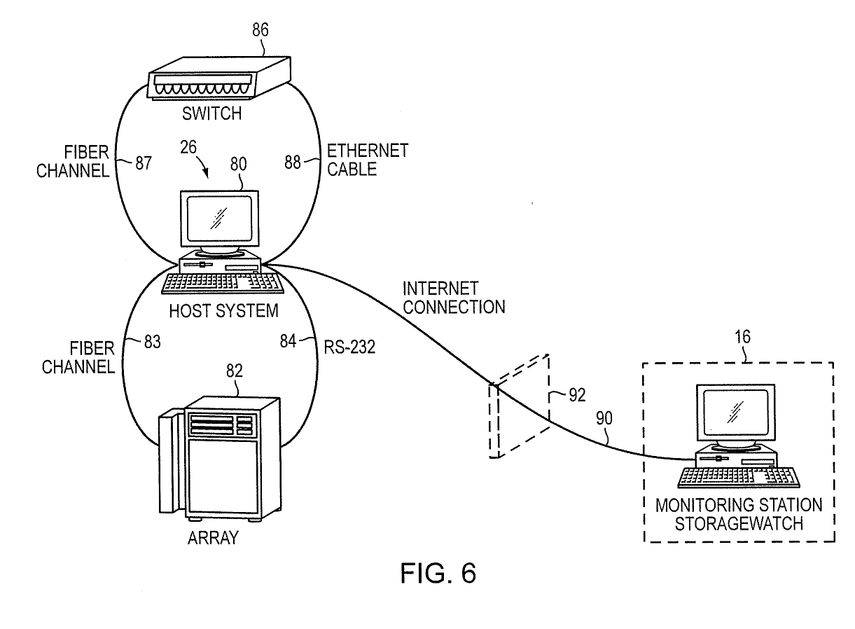

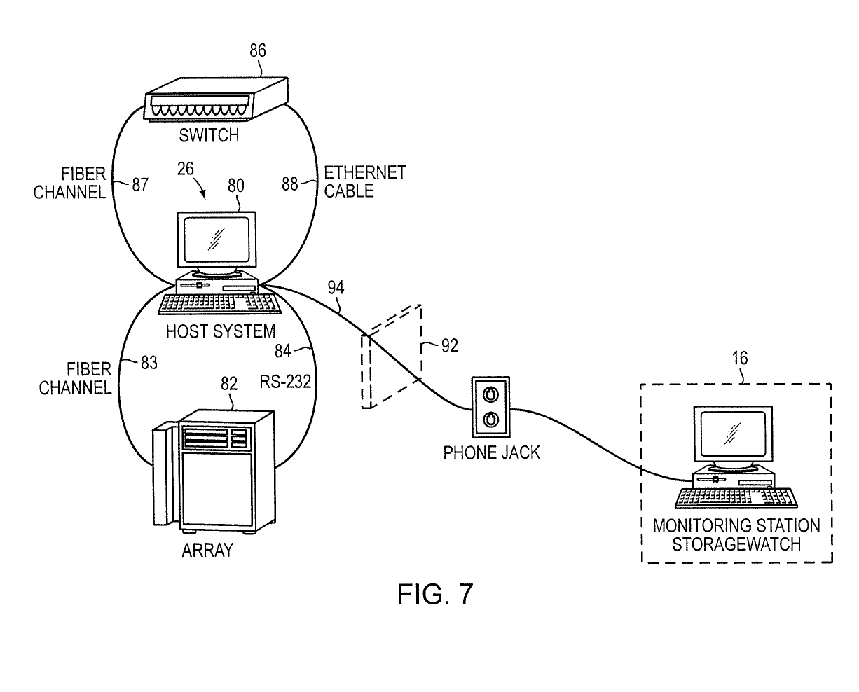

FIGS. 6 and 7 show examples of different customer configurations where the customer location includes a host system 80 that can be used as the storage management system 26. In these configurations, the host system 80 is connected to an array 82 with a fibre channel 83 and/or an RS-232 connection 84 and connected to a switch 86 with a fibre channel 87 and/or an Ethernet cable 88. The central monitoring system 16 monitors the array 82 and/or the switch 86 through the host system 80.

Communications can be established using Terminal Services, HyperTerminal or Telnet. As shown in FIG. 6, the customer environment preferably includes an Internet connection 90 and the host system 80 has a dedicated IP address within the customer's network. This customer configuration allows significant control over the management and monitoring functions of the array because the central monitoring system 16 can connect to the host system 80 over the Internet substantially continuously. This enables full monitoring of the systems of the array and allows the ability to perform changes to the configuration of the array and to perform maintenance, such as firmware upgrades, to the system if deemed necessary. This configuration also allows the use of Terminal Services, HyperTerminal or Telnet to establish communication and allows the use of network monitoring tools such as What's Up Gold or HP OpenView. This configuration may also allow proactive monitoring of SNMP traps if the host system 80 is configured to do so.

This customer configuration also allows monitoring of the switch 86. The switch 86 can be monitored through the host system 80 using its default IP address. More preferably, the switch 86 can be given an outside IP address allowing it to be monitored from the monitoring system 16 and allowing SNMP traps to be sent to the monitoring system 16 to be examined.

If a firewall 92 is used with the Internet connection 90, the monitoring system 16 is given access through the customer's firewall 92 to monitor the systems in a timely manner. To use a virtual private network (VPN), the IP address of the monitoring system 16 can be granted access through the customer's firewall 92. To use Terminal Services, HyperTerminal or Telnet a port is left open or the IP address of the monitoring system 16 is granted access through the customer's firewall 92.

As shown in FIG. 7, the customer environment may only include a dialup connection 94. This configuration allows the ability to monitor the general status of the array 82. Although Telnet, HyperTerminal and SSH may be used to establish communication, the limitations of the dialup connection 94 may limit the ability to use Terminal Services to monitor the controller and to perform any maintenance it may require.

If a firewall 92 is used with the dialup connection 94, access to the firewall 92 can be granted allowing the monitoring system 16 to proactively scan the array 82 and its subsystems for potential failures, which can be resolved before they cause problems. Without access to the firewall 92, the host system 80 can call the monitoring system 16 when it has a problem, deliver the SNMP packets to the monitoring system 16 and then disconnect.

Referring again to FIG. 5, if the customer location does not have a host system that can be used as the storage management system, a storage management server appliance is connected to the storage system(s) at the customer location, step 124. The storage management server appliance is assigned a dedicated IP address within the customer's network and configured to connect to the central monitoring system.

According to one method of setting up and configuring the storage management server appliance, the operating system and the communications software is installed. In one example, a Windows server is installed with Terminal Services in administrative mode. The networking and IP addresses are then configured. One network interface can be set to outside and with a static IP address within the customers network. Another network interface can also be set to inside (e.g., to monitor switches). The appropriate hardware can also be installed in the server appliance, for example, hard drives and host bus adapters (HBA).

Once the operating system is installed and the server appliance is configured for networking, the storage application(s), event monitor and notification agent can be installed. In these examples, the storage application(s), event monitor and notification agent are implemented using storage system management and monitoring software such as the type available under the name RAIDWatch from Infortrend Corporation, the type available under the names Global Array Manager (GAM) and SANarray Manager (SAM) from Mylex, an LSI Company.

In another customer environment, the storage management system may be incorporated in the storage array itself. In this type of environment, the storage management server appliance is not required and communication can be established directly to the storage system, for example, via Telnet or SSH.

Once the system is configured, a substantially constant, live real-time connection can be established and maintained between the central monitoring system and the storage management system at the remote location or customer's site, step 130. The configuration of the remote storage management system can be remotely performed during the initial installation and can also be modified remotely from the central monitoring system. The connection is preferably established from the central monitoring system using the IP address(es) for the storage management system within the customer's network. Security can be maintained by providing a virtual private network (VPN) or by using SSH (Secure Shell) between the customer site and the central monitoring system 16 and by restricting access to data. Also, multiple levels of password authentication can be used to access the storage management system.

According to one exemplary procedure for establishing a connection, a customer is contacted by NOC personnel requesting a “turn-up” schedule and the system is assigned an IP address by the customer (if necessary). The appropriate ports are opened in the customer's firewall, and communication is established, for example, via Telnet, VPN or SSH. The system condition and configuration is recorded. Event notification is turned on and tested, and event notification tests are sent via email. Each customer has a dedicated monitor assigned in the NOC, and each monitor can accommodate up to 4 storage systems.

Connectivity between the central monitoring system and the customer is preferably monitored (e.g., on an hourly basis) to ensure a substantially continuous 24×7 connection. For example, the central monitoring system can repeatedly ping the remote storage management system (e.g., every 3 sec.) to monitor the connection. If connectivity is lost, the user can try to re-establish the connection or the user can follow the procedure for down equipment if connectivity cannot be re-established.

Once the connection is established, the central monitoring system can monitor the overall condition of the remote storage system(s) in real-time, step 140. The user can initiate one or more of the management and monitoring applications from the central monitoring system, for example, using the software interface. In the exemplary embodiment, the thin clients at the central monitoring system display in real-time the data and alerts received by the monitoring applications running on the storage management system.

The components of the storage system(s) and environment that can be monitored include, but are not limited to: the storage system itself; the switches and fabric environments; tape backup systems; HBAs; the OEM board only solution for both six and eight drive versions; environmental conditions such as power and temperature; hard errors of disc, directors, power supplies, fans and switch components; and local weather conditions and alerts.

The central monitoring system can also provide proactive monitoring and/or preventive maintenance. According to one method, thresholds are set within the storage system(s) to alert the central monitoring system and/or the customers of the problems (e.g., system irregularities and component failures) before the problems occur. Examples of these problems include, but are not limited to, soft errors on disc and memory, irregularities in voltage levels, and fans spinning below the recommended RPM.

The central monitoring system can also provide remote administration and management of the storage system(s). Examples of the administrative functions that can be performed include, but are not limited to: volume mapping to new servers added to the SAN; volume re-allocation to different servers in the SAN, parity regeneration (integrity verification) of the volumes; remote upgrades of firmware and software; and reconfiguration of the SAN including fabric, volumes and storage.

Alert notifications can be provided to personnel associated with the central monitoring system and/or to personnel associated with the remote storage system (i.e., the customer). In response to the alert notifications, the personnel associated with the central monitoring system can take measures to prevent the problems, for example, by providing remote administration and management, as described above. The customer's can be notified as little or as much as they desire. Notification can be provided from the central monitoring system personnel to the customer personnel or can be provided directly to the customer personnel (e.g., to the customer's IT personnel) by the storage management system. According to one method, the storage management system provides automatic notification of alerts via SNMP traps (MIB2 compliant), e-mail, page and fax.

According to one preferred monitoring method, reports are generated based on the monitoring and are provided to the customers (e.g., monthly). The reports can describe events within the customer's system as they occur and the corrective action that was needed as well as indicating the overall system health. The reports can include, but are not limited to, system level status and performance, notification summary, usage report, configuration and preventative recommendations, and pro-active maintenance summary.

Accordingly, the system and method of the present invention is capable of providing 24×7 proactive monitoring of a storage system as well as remote configuration and support from a central monitoring system. The system and method allows customers to focus on core business while the central monitoring system remotely monitors and administers the customer's storage system(s). The system and method provides a cost savings in IT personnel and downtime prevention.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

The invention claimed is:

1. A storage monitoring and administration system for remotely monitoring and providing administration to a data storage system, said storage monitoring and administration system comprising:
at least one remote storage management system including:
at least one connection to said data storage system;
software for managing and monitoring said data storage system; and
a connection to a network; and
a central monitoring system including a connection to said network for connecting to each said remote storage management system, wherein said central monitoring system maintains a substantially constant, real-time live connection with each said remote storage management system over said network.

2. The storage monitoring and administration system of claim 1 wherein said connection to said network by each said remote storage management system and said central monitoring system is a TCP/IP connection.

3. The storage monitoring and administration system of claim 2 wherein said connection to said network by each said remote storage management system and said central monitoring system establishes a virtual private network between said central monitoring system and each said remote storage management system.

4. The storage monitoring and administration system of claim 2 wherein each said remote storage management system has at least one dedicated IP address within a network containing said data storage system.

5. The storage monitoring and administration system of claim 1 wherein each said remote storage management system is connected to said data storage system using an in-band connection and an out-of-band connection.

6. The storage monitoring and administration system of claim 1 wherein each said remote storage management system includes a secure communications server for communicating with said central monitoring system.

7. The storage monitoring and administration system of claim 1 wherein said software for managing and monitoring the data storage system includes an event monitor.

8. The storage monitoring and administration system of claim 1 wherein said at least one remote storage management system includes a plurality of remote storage management systems connected to each of said data storage system to provide fail-over support.

9. The storage monitoring and administration system of claim 1 wherein said at least one remote storage management system includes a plurality of remote storage management systems connected to a plurality of data storage systems.

10. The storage monitoring and administration system of claim 1 wherein said central monitoring system includes at least one thin client and a plurality of cluster nodes in communication with said at least one thin client.

11. The storage monitoring and administration system of claim 10 wherein each of said cluster nodes includes:
a secure communications server agent for communicating with said thin client; and
a secure communications client for communicating with said remote storage management system.

12. The storage monitoring and administration system of claim 11 wherein each of said cluster nodes further includes a fail-over agent for exchanging configuration information between said cluster nodes and for re-routing data from failed cluster nodes to surviving cluster nodes.

13. A remote management system for monitoring a data storage system, said remote management system comprising:
an operating system;
at least one storage application;
an in-band connection to said data storage system;
an out-of-band connection to said data storage system;
an event monitor for monitoring events in said storage system and for receiving data and alerts at a real-time level;
a TCP/IP connection to a network; and
a secure communications server for communicating with a central monitoring system using the TCP/IP connection over the network.

14. The remote management system of claim 13 further comprising a notification agent.

15. A central monitoring system for maintaining a substantially constant, real-time live connection with a remote storage management system over a network, said central monitoring system comprising:
at least one thin client including a secure communications client; and
a plurality of cluster nodes in communication with said at least one thin client, each of said cluster nodes comprising:
an operating system;
a secure communications server agent for communicating with said thin client;
a TCP/IP connection to the network for connecting to said remote storage management system;
a secure communications client for communicating with said remote storage management system using the TCP/IP connection over said network; and
a fail-over agent for exchanging configuration information between said cluster nodes and for re-routing data from failed cluster nodes to surviving cluster nodes.

16. A method for proactively monitoring and providing administration to a remote data storage system at a remote location, said method comprising the steps of:
establishing and maintaining a substantially constant, live real-time connection between a central monitoring system and a remote storage management system connected to the remote data storage system at the remote location;
receiving data and alerts pertaining to the data storage system;
accessing said data and alerts over the real-time connection; and
displaying said data and alerts in real time at the central monitoring system.

17. The method of claim 16 further comprising the step of setting thresholds with respect to said data storage system to provide alerts indicating problems before the problems occur.

18. The method of claim 16 further comprising the step of providing remote administration and management of said data storage system.

19. The method of claim 16 further comprising the step of providing alert notifications to personnel associated with said central monitoring system and/or to personnel associated with said data storage system.

20. A method of providing a remote storage monitoring and administration service, for a data storage system at a remote customer location, said method comprising the steps of:
ascertaining a customer configuration at said customer location;
configuring a remote storage management system at said customer location depending upon said customer configuration;
establishing and maintaining a live real-time connection between a central monitoring system and said remote management system configured at said customer location;
receiving data and alerts pertaining to said data storage system;
accessing said data and alerts over said real-time connection; and
displaying said data and alerts in real-time at said central monitoring system.

21. The method of claim 20 wherein the step of configuring said remote storage management system includes:
connecting a storage management appliance to said customer location; and
assigning said storage management appliance a dedicated IP address within a network at said customer location.

22. The method of claim 20 wherein the step of configuring said remote storage management system includes:
configuring an existing host system at said customer location to connect to said central monitoring system.

23. A storage monitoring and administration system for remotely monitoring and providing administration to a data storage system, said storage monitoring and administration system comprising:
at least one remote data storage system connected to a network; and
a central monitoring system connected to said at least one remote data storage system via said network, wherein said central monitoring system maintains a substantially constant, real-time live connection with each said remote data storage system over said network.

24. The storage monitoring and administration system of claim 23 wherein said connection to said network by each said data storage system and said monitoring system is a TCP/IP connection.

25. The storage monitoring and administration system of claim 23 further comprising a LAN port wherein said at least one remote date storage system is connected to said central monitoring system via an IP address.

26. A method for proactively monitoring and providing administration to a remote data storage system at a remote location, said method comprising the steps of:
establishing and maintaining a substantially constant, live real-time connection between a central monitoring system and a remote data storage system at the remote location;
receiving data and alerts pertaining to said data storage system;
accessing said data and alerts over said real-time connection; and
displaying said data and alerts in real time at said central monitoring system.

27. The method of claim 26 further comprising the step of providing remote administration and management of said remote storage system.
